(19) United States
(12) Patent Application Publication
(10) Pub. No.: US 2006/0047419 A1
(43) Pub. Date: Mar. 2, 2006

(54) Telematic method and apparatus for managing shipping logistics

(76) Inventors: John R. Diendorf, Naperville, IL (US); James S. Wolsieffer, Schaumburg, IL (US); Ronald E. Bolanowski, Vernon Hills, IL (US); David Scan St Leger-Andrews, San Carlos, CA (US); John M. Schullian, Tower Lakes, IL (US); Christopher J. Weseloh, Mount Prospect, IL (US)

Correspondence Address: WHYTE HIRSCHBOECK DUDEK S C, 555 EAST WELLS STREET, SUITE 1900, MILWAUKEE, WI, 53202, US

(21) Appl. No.: 11/073,924

(22) Filed: Mar. 7, 2005

Related U.S. Application Data
(60) Provisional application No. 60/606,590, filed on Sep. 2, 2004.

(51) Int. Cl. G01C 21/32; G01C 21/30

(52) U.S. Cl. 701/208; 340/539.1; 340/933; 340/552

(57) ABSTRACT

Shipping logistics are managed by monitoring the location and at least one operational characteristic of the mobile shipping unit, the operational characteristic selected from the group consisting of internal temperature, external temperature, acceleration, weight, hatch status and combinations thereof; communicating at scheduled intervals data comprising the location and monitored characteristic from the mobile shipping unit to a receiving device that is remote from the mobile shipping unit; storing the data received by the receiving device in a status database, wherein the status database is in electronic communication with a data processing unit; processing the data stored in the status database with the data processing unit to generate at least one report on the mobile shipping unit and to determine if an alert condition exists, wherein an alert condition exists when any data point is outside predetermined limits; determining a nature and severity of any existing alert condition; generating an alert notification based on the nature and severity of the alert condition; and, providing access to the reports and alerts via a network, the network comprising the Internet, an intranet or a combination of both.

### CROSS REFERENCE TO RELATED APPLICATIONS

This application claims the benefit of U.S. Provisional Application Ser. No. 60/606,590 filed Sep. 2, 2004, the teachings and disclosures of which are herein incorporated by reference.

### BACKGROUND OF THE INVENTION

This invention relates generally to managing shipments of goods, and more specifically to methods and apparatus for monitoring the status of shipments and shipping vehicles and reporting on that status.

Shipment of materials, especially chemical materials, frequently require large fleets of mobile transportation units and can provide reasons for environmental and safety concerns. Therefore, a system that can monitor the status of the shipping units and the cargo and communicate such status in the forms of reports and alerts is highly desirable for the shipping industry.

### BRIEF SUMMARY OF THE INVENTION

A hallmark of the current invention is a system and apparatus for monitoring and controlling logistics regarding the bulk shipment of materials, especially chemicals.

In one embodiment, the invention is a method for managing mobile shipping units, the method comprising the steps of: monitoring at least one operational characteristic of the mobile shipping unit, the operational characteristic selected from the group consisting of internal temperature, external temperature, acceleration, weight, hatch status and combinations thereof; monitoring the location of the mobile shipping unit with a global positioning system; communicating at scheduled intervals data comprising the location and monitored characteristic from the mobile shipping unit to a receiving device that is remote from the mobile shipping unit; storing the data received by the receiving device in a status database, wherein the status database is in electronic communication with a data processing unit; processing the data stored in the status database with the data processing unit to generate at least one report on the mobile shipping unit and to determine if an alert condition exists, wherein an alert condition exists when any data point is outside predetermined limits; determining a nature and severity of any existing alert condition; generating an alert notification based on the nature and severity of the alert condition; and, providing access to the reports and alerts via a network, the network comprising the Internet, an intranet or a combination of both.

In a further embodiment, the invention is a method to minimize environmental contamination during transportation; the method comprising the steps of: monitoring the current loaded weight and location of a mobile transport unit, wherein the unit contains a potentially environmentally hazardous material; communicating at scheduled intervals data comprising the location and loaded weight from the mobile shipping unit to a processing system that is remote from the mobile transport unit; comparing the current loaded weight of the mobile shipping unit with a target loaded weight, the target loaded weight being an average of previously communicated loaded weights, the immediately previously communicated loaded weight, or an original loaded weight; determining if the mobile transport unit is within a predetermined geofence (virtual geographic boundary), the geofence defining a boundary around a station for loading or unloading the material from the mobile transport unit; communicating an alert message if both (1) the comparison of the current loaded weight with the target loaded weight determines that the loaded weight has changed by more than a predetermined amount and (2) the mobile unit is not within a geofence, are true.

In another embodiment, the invention is a system for managing mobile shipping units, the system comprising: means for monitoring at least one operational characteristic of the mobile shipping unit, the operational characteristic selected from the group consisting of internal temperature, external temperature, acceleration, weight, hatch status and combinations thereof; means for monitoring the location of the mobile shipping unit with a global positioning system; means for communicating at scheduled intervals data comprising the location and monitored characteristic from the mobile shipping unit to a receiving device that is remote from the mobile shipping unit; a status database for storing the data received by the receiving device in a status database; a data processing unit in electronic communication with the status database, the data processing unit adapted to process the data stored in the status database to: (1) generate at least one report on the mobile shipping unit and to determine if an alert condition exists, wherein an alert condition exists when any data point is outside predetermined limits; (2) determine a nature and severity of any existing alert condition; and (3) generate an alert notification based on the nature and severity of the alert condition; and, means for providing access to the reports and alerts via a network, the network comprising the Internet, an intranet or a combination of both.

In yet another embodiment, the invention is a method for monitoring the status of a mobile shipping unit, the method comprising the steps of: communicating data comprising the location and monitored characteristics from the mobile shipping unit to a receiving device that is remote from the mobile shipping unit, wherein the monitored characteristics comprise at least one of internal temperature, external temperature, acceleration, weight, hatch status or combinations thereof; storing the data received by the receiving device in a status database, wherein the status database is in electronic communication with a data processing unit; processing the data stored in the status database with the data processing unit to generate at least one report on the mobile shipping unit, wherein the report comprises at least one of an estimated time of arrival for the mobile shipping unit, idle time, mis-routing of the mobile shipping unit, cargo status, key performance indices, or fleet performance statistics; and providing access to the reports and alerts via a network, the network comprising the Internet, an intranet or a combination of both.

Another embodiment of the invention is a method for automatic invoicing, the method comprising communicating data comprising the location, weight, and, optionally, the hatch status, of a mobile shipping unit to a receiving device that is remote from the mobile shipping unit; storing the data received by the receiving device in a status database, wherein the status database is in electronic communication with a data processing unit; storing bill of lading (BOL) information for the mobile shipping unit in the status database; processing the data stored in the status database with the data processing unit to determine if the mobile shipping unit has been tapped and/or unloaded by a customer; and communicating the tapped/unloaded status of the mobile shipping unit to an ERP software application.

### BRIEF DESCRIPTION OF THE DRAWINGS

Preferred embodiments of the invention are described below with reference to the following accompanying drawings, which are for illustrative purposes only. Throughout the following views, reference numerals will be used in the drawings, and the same reference numerals will be used throughout the several views and in the description to indicate same or like parts or steps.

FIG. 1 is a flow chart of the inventive process.

FIG. 2 is a functional architecture diagram.

FIG. 3 is a screen print of the Telematics HomePage.

FIG. 4 is a screen print of the General Reporting Page.

FIG. 5 is a screen print of the Site Turn Oval.

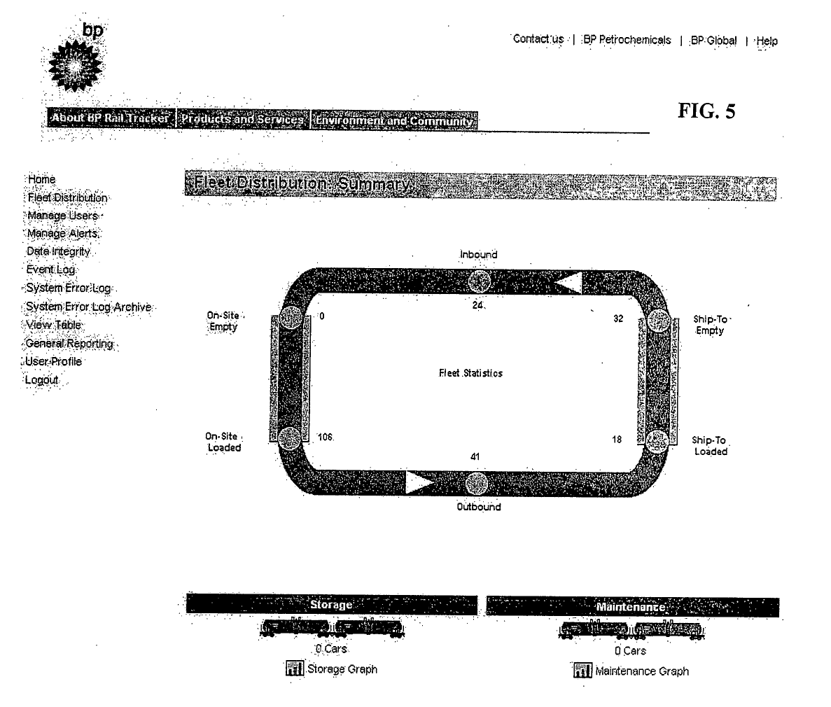

### DETAILED DESCRIPTION OF THE INVENTION

As used herein, the term “users” means any person authorized to access the inventive system or the information in the system. Such authorization typically arises from the duties or responsibilities associated with the users role or position. Non-limiting examples of such users are account managers/customer service representatives (CSR), customers, site controllers, terminal coordinators, Health Safety Security and Environment (HSSE) personnel, maintenance personnel, business managers, etc.

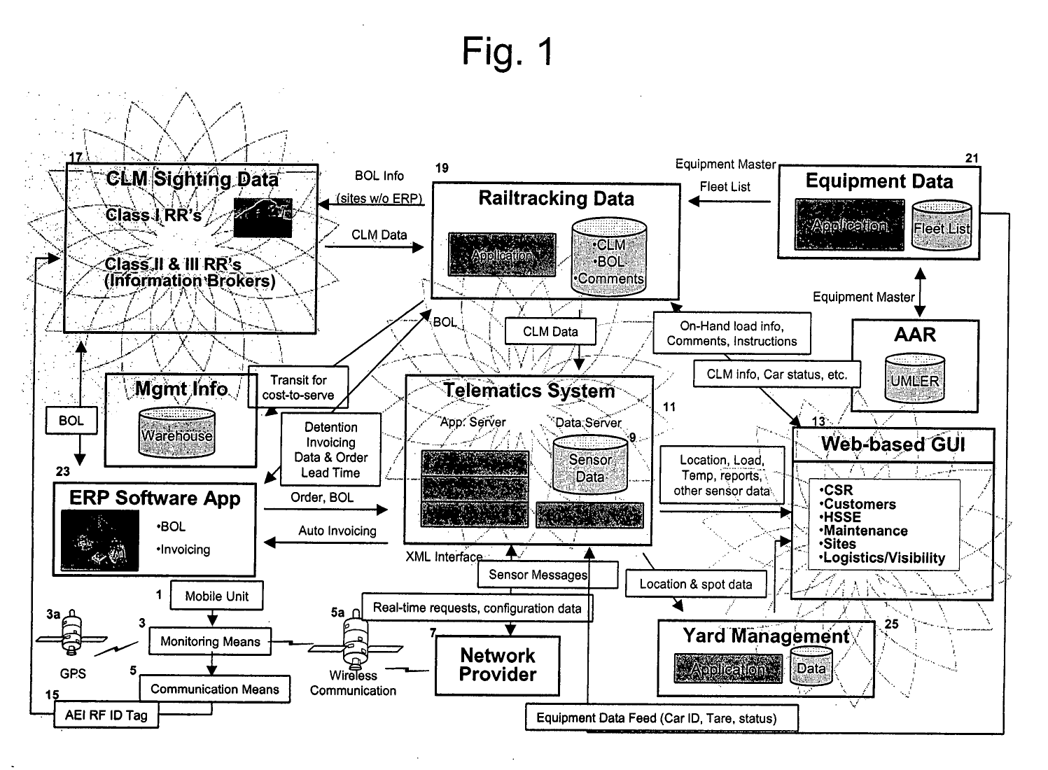

FIG. 1 shows a flowchart of subprocesses of the inventive process. These subprocesses, and other optional subprocesses will be described in more detail in subsequent figures and text below. A mobile unit 1 is equipped with monitoring means 3 for measuring certain physical parameters related to mobile unit 1 and any cargo therein. Mobile unit 1 may be any vessel or vehicle capable of transporting a material but is preferably adapted for bulk transport of the material. Mobile unit 1 is preferably a railcar, ship or barge.

While this invention pertains to the shipment of any type of material, the invention may be particularly useful for shipping chemicals, potentially hazardous materials, or bulk materials that are sensitive to environmental conditions.

Monitoring means 3 is equipped with sensors for measuring at least one desired parameter, such as: location, loaded weight, acceleration, external temperature, internal temperature, hatch open/close status, etc. For a double-walled tank unit, the internal temperature may be the temperature of the internal wall. The sensors preferably provide digital electronic output signals or else analog output signals that can be translated into digital signals. Preferably, the location is measured via global positioning satellites, as is well known in the art, e.g., U.S. Pat. No. 6,496,777 B2 and U.S. Pat. No. 6,704,626 B1. External and internal temperatures can conveniently be measured by well-known means such as thermocouples or infrared temperature sensors, preferably thermocouples.

Monitoring means 3 is in electronic communication with mobile communications means 5. Mobile communication means 5 is able to store digital data signals from the sensors of monitoring means 3 and send those data signals, via a satellite or cellular communication network, to a central receiving station 7. At the central receiving station 7, the data signals are cleaned, validated and then entered into a database 9. Database 9 is maintained on a computer readable medium, such as the data server shown in FIG. 1, digital tapes, compact discs, hard drives, etc.

The mobile communication means 5 can be programmed to transmit a data signal to the central receiving station 7 on a periodic basis, e.g., twice a day, on demand, when a significant condition occurs as determined by the sensors, or a combination thereof. Conveniently, the periodic basis can be set-up to transmit a signal so that the database 9 is updated at the beginning and/or end of the workday or work shift of system Users.

Other, alternative sources of information on the shipment can also be incorporated into the database. For instance, in the U.S., many railroads have CLM (Car Location Message) 17 capability. CLM 17 sighting data can be obtained from commercial sources, such as Class I: Railroads, or Information Brokers, such as Kleinschmidt or Net REDI. CLM 17 comprises an electronic optical sensor located on the side of a rail track that can read coded information 15 displayed on the side of a railcar. CLM 17 can provide location information that can be used to augment, GPS information. Other sources of information can include databases of historical information relative to individual units. For example, a database 21 could provide the tare weight and unit type (e.g., tank, hopper, boxcar, etc.) of a mobile unit 1. Historical data can be obtained from databases 21 such as Alltranstek's Fleetwatch.

Likewise, information from accounting, billing or order fulfillment databases 23 can be included. Such information could allow the system to automatically send an invoice when a consignment shipment is tapped or charge demurrage if an empty mobile unit 1 is held at a customer's facility for too long before being released for pick-up.

The information in database 9 is processed by appropriate algorithms and scripts. The algorithms and scripts produce reports 11 that are accessible by Users of the system. Preferably, Users access the system through a Web based Graphical User Interface (GUI) 13, such as the Internet, an intranet, or both. The system provides and formats reports 11 based on the function of the User. For example, a User can log into system through the GUI 13 using a password. As the User logs onto a system, they begin at their corresponding home page. Only information, modules, and tasks that are relevant to the User role and to which the User has permission to execute are displayed on the home page. Users can navigate from their home page by module and within a module by level. From any level within any module, Users can navigate back to their home page, any level 1 module, or any level 2 task within individual modules. The nature of the modules, levels and navigation is illustrated in more detail in the examples.

The reports can include overall or historical summaries. For example, reports may summarize Key Performance Indicators (KPI) such as rail turns, on-time deliveries, inventory levels, on-site/in-transit car ratios, etc. The reports may also provide information on overall fleet performance which is useful in modeling fleet size to obtain maximum utilization of the assets. The summary reports may also be used to identify issues of potential future concern such as locations that have a significant number of high acceleration events, switching yards that cause extended idle time for cars or customers that consistently send mobile units back with large heels. A heel is product remaining in the mobile unit after it has been unloaded.

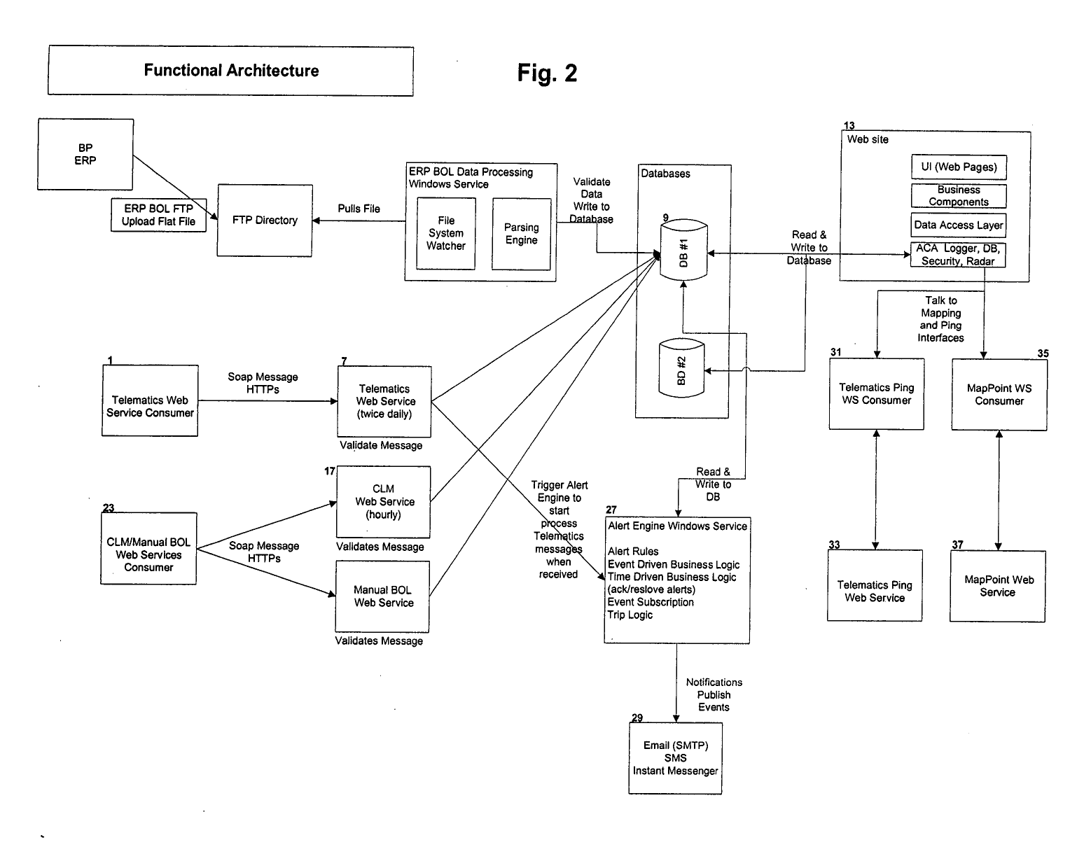

As shown in FIG. 2, an alert engine 27 also processes the database 9 to determine if an alert condition exists. An alert condition exists if a particular sensor reading is outside of a predetermined range. The predetermined range can consist of either a single limit value (i.e., a minimum or maximum) or can constitute a double-ended range having a both a minimum and maximum. For example, the estimated time of arrival (ETA) of a shipment would generate an alert only if the ETA exceeded the requested delivery date. In contrast, certain sensitive materials might be damaged by freezing if the temperature is too cold or degrade if the temperate is too high and therefore would have both a minimum and a maximum temperature range. An alert condition also exists if a sensor reading indicates a change in a parameter, e.g., loaded weight, either beyond a predetermined range or when the mobile 1 is outside of a predetermined area defined by a geofence.

The alert engine also determines the nature and the severity of the alert condition. The nature of the alert condition is based on whether the alert is recurring from the previous report or is a single event. For example, an empty rail mobile unit frequently will sit idle on a siding for days or weeks at a time. When two consecutive geo positioning sensor readings are substantially identical, the alert engine will determine that an alert condition exists and designate that alert condition as a first time or new alert. If a number of subsequent geo position sensor readings indicate that the location of the mobile unit is still substantially the same (i.e., the mobile unit is idle) the alert engine will still determine that an alert condition exists but will designate this as an ongoing or recurring alert condition. A repetitive alert condition is when different units experience the same alert (i.e., each unit goes idle at the same relative location).

The alert engine determines the severity of an alert condition based on a number of criteria that include the area of responsibility for the User of the system. For example, an idle unit alert for an empty rail car or barge would likely be of little concern to most Users except those that have responsibility for managing the system assets. Also, an alert indicating that a loaded mobile shipping unit has been misrouted or is delayed is of concern to Users having responsibility for delivering the product to customers or to customers waiting for receipt of the shipment but would not interest Users responsible for maintenance or safety of the units or shipments. On the other hand, an alert condition showing an acceleration event which indicates that the mobile shipping unit had a significant collision with another object could be a serious condition to a User interested in maintaining that mobile shipping unit or in general HSSE issues but would not necessarily concern a logistics User if the mobile shipping unit continued the trip without delay.

As shown in FIG. 2, the alert engine 27, and communications to database 9, can be handled by Windows service. Windows 2000 Servers have been found suitable for hosting the inventive telematics application, including the alert engine, as well as supporting components ;and programs. Likewise, a Windows 2000 server can be used to host database 9 and facilitate communications therewith.

The system provides notices 29 to system Users regarding pertinent alert conditions. Typically, these notices consist of messages the User would receive at a User interface to the system, e.g., a computer connected to the system via the Internet. However, the alert notification protocol can be tailored to match a particular User's preferences and/or reflect the seriousness of the alert condition. As an example, an HSSE User may have the notification protocol programmed to provide him with an email alert or an alert to his pager in the event of a serious acceleration incident.

The system can also provide means for the User to request a real time data update from any mobile shipping unit. This allows a User to determine if an alert condition still exists or to obtain further information upon which to act in resolving the alert. The User activates the update request for (Ping) 31 which alerts the service provider 33 to contact the monitoring means 3 and communication means 5 to obtain current conditions. The User may also access map services 35 and 37 to view the location of mobile unit 1.

A number of modules can be built into the system architecture. A non-exhaustive list of such modules, also all “Use Cases” is shown in Table 1.

TABLE 1
EXAMPLE USE CASES

| | Use Case | Description |
|---|---|---|
| 1 | View Mobile unit | In tracking mobile units, it is important for Users to see the |
| | ETA | Estimated Time of Arrival (ETA) at either the destination or back |
| | | again at the origin. This information is available from estimates |
| | | based on historical calculations of the same trip, and routinely |
| | | updated by the railroad if that ETA changes. This information is |
| | | critical to business decisions relative to customer service and asset |
| | | utilization at the plant site. |
| 2 | View Bad Ordered | As part of the visibility to mobile unit status along the trip, the User |
| | Mobile units | needs to view all mobile units that have been marked as bad |
| | | ordered. The status bad ordered is assigned by the railroad and |
| | | signifies that a railcar with mechanical problems has been rerouted |
| | | to a maintenance facility for repair. Loaded, bad ordered cars are of |
| | | significant concern as this usually means that the car is carrying |
| | | product that will not be delivered to the customer on time. |
| 3 | View Mobile unit | Through their personalized view of the application, Users can see |
| | Status Information | summary and detail information about mobile unit status across their |
| | | area of responsibility. This information is available real-time, and |
| | | includes all of the relevant information for a particular mobile unit. |
| | | This includes all sensor readings from the telematics unit, order |
| | | information, delivery information, and derived information based on |
| | | business rules. Mobile unit status can be viewed through an easy |
| | | customized reporting tool, or as part of key alerts triggered by a |
| | | User's role and preferences. |
| 4 | View Site Mobile | Through a different view of status information, Users can access |
| | unit Statistics | real-time views of all mobile units on site and their status. This |
| | | view helps Users manage both mobile units and inventory at various |
| | | locations on a particular site. |
| 5 | View Inbound | Through a different view of status information, Users can access |
| | Mobile units | real-time views of all mobile units inbound to the site and their |
| | | status. This view helps Users with several of their key |
| | | responsibilities: order demand planning, production planning, on |
| | | site asset utilization efficiency/planning. |
| 6 | View Mobile unit | The application can determine and display mobile unit idle times. |
| | Idle Time (incl. | Many Users will be interested in tracking these idle times within |
| | Demurrage) | specific geo-fences: customers, terminals, sidings, plant/storage |
| | | sites, in transit locations. Business rule capability can also calculate |
| | | the corresponding demurrage incurred (by both customer and |
| | | SHIPPER) at those locations where idle times have exceeded the |
| | | contractual limit. |
| 7 | Alert of Idle Mobile | Through the application business rule capability, Users are notified |
| | unit | immediately of mobile unit idle times outside of maximum |
| | | tolerances. With appropriate action, this reduces trip delays, as well |
| | | as opportunity to incur demurrage charges. |
| 8 | Notify Mobile unit | Through the business rule capability, the application can use the |
| | Unload | telematics load sensor readings to determine mobile unit unload or |
| | | tapped status at a VIM (Vendor Inventory Management) customer |
| | | location. This information can then be fed to a system that monitors |
| | | consignment inventory and usage as part of their on site inventory |
| | | monitoring capability. |
| 9 | Receive CLM | The application will receive event-based CLM data to supplement |
| | Information | the telematics location information. The CLM data provides input |
| | | on railroad activity, as well as railroad ownership of the mobile unit |
| | | at any point in time (with the exception of customer/terminal/plant |
| | | sites). |
| 10 | Receive Mobile | The application will receive real-time telemetry data from the |
| | unit Telemetry Data | mobile telematics unit. The telemetry data provides readings from |
| | | the sensors including location, weight, temperature, and impact. |
| 11 | Notify Mobile unit | Through the business rule capability, the application can use the |
| | Load | telematics load sensor readings to determine carload status at a plant |
| | | site location. This information can then be fed to the SAP system in |
| | | preparation for mobile unit shipment. |
| 12 | Alert on Placement | Create system-generated alerts notifying Users of mobile unit |
| | | placement at the site (plant/customer/terminal/storage). These alerts |
| | | can be based on both CLM event placement codes and/or geo-fence |
| | | parameters. |
| 13 | Alert on Sensors | Create system-generated alerts on sensor readings outside of |
| | outside threshold | business-outside threshold defined thresholds. These alerts can be |
| | (incl. Derailment) | routed to specific Users based on their role or customized |
| | | preferences. |
| 14 | Alert on Misrouted | Create system-generated alerts notifying Users of misrouted mobile |
| | Mobile units | units. Initially, the application will generate these alerts based on |
| | | comparison of the BOL versus customer geofence and the ETA. |
| | | Once the system can capture route history for multiple trips, |
| | | business rule capability could be used to determine mis-routes |
| | | before they reach the customer site. Additionally, misroute status |
| | | information can be received as a status through RoadRunner. |
| 15 | View Order Details | Users can view mobile unit details on those orders they are most |
| | (BOL, Certificate of | concerned about tracking (or vice versa). This information is |
| | Analysis (COA)) | available to a User across their particular area of responsibility and |
| | | includes all pertinent ERP SOFTWARE APPLICATION order |
| | | details. |
| 16 | Send Invoice | Through the business rule capability, the application can use the |
| | Initiation | telematics load sensor readings to determine mobile unit unload or |
| | (Consignment) | tapped status at a consignment customer location. This information |
| | | can be fed to the ERP SOFTWARE APPLICATION system and |
| | | automatically initiate a customer invoice. |
| 17 | Receive Order Feed | The application will receive both ERP SOFTWARE |
| | | APPLICATION customer and inter-company order details once the |
| | | loaded mobile unit has been assigned to an order. In addition, any |
| | | order updates or changes will be included in the order feed from |
| | | ERP SOFTWARE APPLICATION. |
| 18 | Send Demurrage | Through the business rule capability, the application can use the |
| | Invoice Initiation | telematics location/geofence readings to determine duration of idle |
| | | times at customer locations. This information can be fed to the ERP |
| | | SOFTWARE APPLICATION system and automatically initiate a |
| | | customer invoice for idle times over contractual limits. |
| 19 | Send FOB Invoice | Through the business rule capability, the application can use the |
| | Initiation | telematics location/geofence readings to determine when a mobile |
| | | unit enters a particular area of interest. This information can be fed |
| | | to the ERP SOFTWARE APPLICATION system and automatically |
| | | initiate a FOB (Free on Board) invoice after crossing a geofence. |
| 20 | Determine | Account Mangers and Customers can define key product usage |
| | Customer Usage | metrics and information they are most concerned about tracking on |
| | | the customer site. Through the business rule capability, the |
| | | application can determine customer usage based on depletion of |
| | | mobile unit inventory over time. Typically, this information is only |
| | | available through the customer and was not available as a real-time |
| | | reporting capability. |
| 21 | Notify Usage | Through the business rule capability, the application can use the |
| | History | telematics load sensor readings to determine customer usage history. |
| | | This information can then be fed to the IDSP (Integrated Demand |
| | | Supply Planning) system as an input into forecasting models. |
| 22 | Create Risk | To support key HSSE initiatives within a company and their |
| | Assessment Report | customers, the system can generate risk assessment reports for |
| | | specific rail routes. This report manipulates input on products, |
| | | population areas and trip route information to determine the |
| | | calculated risk associated with specific customer deliveries. |
| 23 | Infer Geofence | To support a company's existing customer base, as well as new |
| | | customers that will be added over time, the application will infer |
| | | geofences based on the BOL ship-to address. This capability will |
| | | assist in ensuring a geofence is established for all customers, and |
| | | will be manually refined as necessary. |
| 24 | Send Route Transit | The application can determine accurate route transit times. This |
| | Time | information can be fed to the ERP SOFTWARE APPLICATION |
| | | system to continually update route transit times with more refined |
| | | data. |
| 25 | Maintain | Through system administration tools, Users can update the database |
| | Population | with location and population information along routes. This data |
| | Information | will be a key input into the HSSE Risk Assessment Report. |
| 26 | View Current | Through role-based reporting views, Users are able to see summary |
| | Product Inventory | information about product inventory in railcars across their area of |
| | | responsibility. This information is available real-time and is a quick |
| | | and easy method to view accurate inventory levels that is not visible |
| | | today. |
| 27 | Maintain KPIs | Business Managers have key metrics and targets that they are most |
| | | concerned about tracking: rail turns, on-time deliveries, inventory |
| | | levels, on-site/in-transit mobile unit ratios, etc. The application can |
| | | store target values to indicate whether Users are managing their |
| | | portion of the rail cycle appropriately. |
| 28 | View KPIs (Mobile | Through role based reporting views, Users are able to see summary |
| | unit Status, Time, | information on how real rail car activities compare to their targets. |
| | Desired Values, | This up to date information allows them to adjust their focus and/or |
| | Number of Mobile | take corrective actions. |
| | units) | |
| 29 | Maintain Inventory | Account Managers and Terminal Coordinators have target product |
| | Thresholds | inventories they need to manage at customer and terminal locations. |
| | | The application can store minimum and maximum values to serve as |
| | | key indicators of business action. This type of information coupled |
| | | with customer usage history can be effective in managing overall |
| | | inventory flow across customers and terminals. |
| 30 | Alert on Multiple | Create system-generated alerts on multiple unload sensor readings |
| | Taps | on mobile units with the same product grade/type inside a terminal |
| | | geofence. These alerts can be routed to specific terminal |
| | | coordinators and helps them enforce the FIFO (First In First Out) |
| | | policy within terminals. |
| 31 | Alert on | Create system-generated alerts for Users, including Customers, |
| | Anticipated Late | Terminal Coordinators and CSRs, when a specific railcar's ETA is |
| | Arrivals | after the ERP SOFTWARE APPLICATION order's requested |
| | | delivery date. |
| 32 | Alert on | Create system-generated alerts on unload sensor readings outside of |
| | Leaking/Vandalized | a specified geofence. These alerts are key information for HSSE |
| | Mobile units | Users that are interested in real-time notification of significant |
| | | mobile unit weight loss during the in-transit portion of the trip. This |
| | | could be an indication of a leak or vandalism. |
| 33 | Alert on Inventory | Create system-generated alerts when target product inventory levels |
| | Events | within a customer or terminal geofence reach either the minimum or |
| | | maximum thresholds. |
| 34 | Configure Alert | Through the application, Users can configure the alerts they want to |
| | Notification | receive and by what means they want to receive them. Users will |
| | Preferences | have the option to receive alerts directly via customized reports, |
| | | email, text messages, etc. |
| 35 | Assign (Delegate) | The application can provide functionality that allows Users to assign |
| | Alerts to Alternate | their alert notifications to another User. In the case of a CSR (or any |
| | Users | User) who is out of the office or unavailable, they can direct their |
| | | alert notifications to an alternate User in their absence. |
| 36 | Alert on Bad | Create system-generated alerts notifying the Users of bad ordered |
| | Ordered Cards | cars. This information is key for Users managing loaded cars to the |
| | | customer. An alert on a bad ordered car in transit often signifies that |
| | | business action should be taken to meet customer needs through an |
| | | alternate shipment. |
| 37 | Alert on | Create system-generated alerts notifying a User when a mobile unit |
| | Geographic Areas | enters or leaves a specific geographic area. This provides the |
| | | capability to monitor and proactively manage the movements of |
| | | specific mobile units. |
| 38 | View Fleet | Through role based reporting views, Users are able to see summary |
| | Performance | information on overall fleet performance. This information serves |
| | Statistics | as a key input into the fleet sizing model, providing both trip in- |
| | | transit and hold times, as well as their standard deviation. |
| 39 | View ETA | Through role based reporting views, Users are able to see real-time |
| | Accuracy | data on the accuracy of actual ETA versus both the system generated |
| | | ETA (e.g., RoadRunner) and the railroad ETA. This information |
| | | can signify that an adjustment should be made if actual ETA trends |
| | | are deviating from the system calculations. |
| 40 | Maintain Users | The application can store User profiles, including the business unit |
| | | (BU), role and permissions. In addition, Users have the ability to |
| | | readily update their profiles based on a change/update in |
| | | responsibility area. |
| 41 | Maintain Alert | The application can store pre-determined alert thresholds to serve as |
| | Thresholds | key indicators of business actions. This information will be |
| | | provided on each of the telematics sensors, in addition to |
| | | derived/calculated data. Alert thresholds will vary depending on a |
| | | number of factors: business unit, fleet, product type, customer, site, |
| | | etc. These thresholds will provide baseline alerts for particular roles |
| | | and can be supplemented with customized alert thresholds. |
| 42 | Maintain Geofence | The application can store pre-determine geofences around any |
| | | geographical area of interest. Initially, we will create geofences |
| | | around known areas: plant sites, terminals, storage tracks, some |
| | | customer locations, etc. This tool will also provide a mechanism to |
| | | update and refine automatically generated (inferred) geofences. |
| 43 | View Historical | Site Logistics Users have key metrics and information that they are |
| | Site Stats | most concerned about tracking, including number of cars on site, |
| | | their status and location. It is not only important for these Users to |
| | | know their current site statistics, but also to understand how those |
| | | statistics have fluctuated/changed over time. With a view of |
| | | historical information, coupled with current site statistics, the |
| | | application becomes a key tool for determining trends or issues |
| | | before they happen. |
| 44 | Receive On-Site | The application will receive information from the plant site's |
| | Loaded Inventory | internal tracking and shipping system. Specific data will include on- |
| | | site loaded car inventory, including asset number, total weight, |
| | | product contained and current status. All loaded cars on site may |
| | | not be available for shipment once loaded, so the status indicator |
| | | tracks them from loading and quality testing through to placement in |
| | | inventory or order assignment. In addition to location and load |
| | | status, this information is critical to managing the fleet on site. |
| 45 | Capture Daily Site | The application will record daily site statistics. This information |
| | Stats | can be used for calculating averages (See Use Case 43) and trends |
| | | (See Use Case 46) |
| 46 | View Future Site | The application tracks current and historical site statistics, including |
| | Projections | the location and status of incoming cars (See Use Case 45). With |
| | | usage/historical information relative to the ratio of cars inbound |
| | | versus outbound, and real-time data on incoming cars, the |
| | | application can provide a projection of future site statistics. This |
| | | information can be used as a planning tool for site management, as |
| | | well as a key indicator for car flow/turn issues. |
| 47 | Add | The application will allow Users to post notes/comments about a |
| | Notes/Comments | particular car. This helps supplement the data for a car and add to |
| | | the audit trail. |
| 48 | View | The application will allow Users to view notes/comments about a |
| | Notes/Comments | particular car. |
| 49 | Forward/Assign | The application will allow Users to post notes/comments about a |
| | Responsibility for | particular car. This helps supplement the data for a car and add to |
| | Note/Comment | the audit trail. In addition, Users may assign responsibility for |
| | | follow-up to a specific User. This User will then receive an alert |
| | | asking for their response. |
| 50 | Alert on Flagged | The application will alert site Users when a car is inbound to their |
| | Car Returning | site that has been flagged (designated by the railroad) for inspection |
| | | (flag is part of car status) |
| 51 | Alert on Response | After a User assigns a note/comment to another User for follow-up |
| | to Note/Comment | and that User has responded, the first User will receive notification. |
| | | This will save time spent in checking for a response until a response |
| | | has been given. |
| 52 | Receive Fleet | The application will receive fleet information from UMLER |
| | Information | (Universal Machine Language Equipment Register), as well as |
| | | regular updates to the fleet. |
| 53 | View Historical | The application will allow Users to view and query historical HSSE- |
| | HSSE Stats | related data for a given time period. This data may include the |
| | | number of HSSE alerts or number of sensors outside acceptable |
| | | limits. Details and related Notes/Comments will be made available |
| | | as supporting details |
| 54 | View General | The application will provide a generalized reporting tool to allow |
| | Reporting | Users to run reports on a wide-variety of data, including Fleet |
| | | Performance, Inventory and KPIs. In addition, the User will be able |
| | | to access any car or subset of cars within a fleet based on various |
| | | input criteria. |
| 55 | View Home Page | The application will provide Users with a specific home page |
| | | customized to their role. |
| 56 | View Application | The application will allow system administration Users to view and |
| | Security | update both authorization and authentication for the application. |
| 57 | View Telematics | The application will allow Users to view the ‘health’ of selected |
| | Unit “Health” | telematics units, including battery and signal strength or indications |
| | | of hardware issues. |
| 58 | Send abnormal | The application will send a notification to the Incident and Accident |
| | sensor readings | Reporting Tracking system when an abnormal reading has been |
| | | detected from a car that may indicate an HSSE problem (formerly |
| | | 52). |

### EXAMPLES

### Example 1

### View Car ETA (All Users)

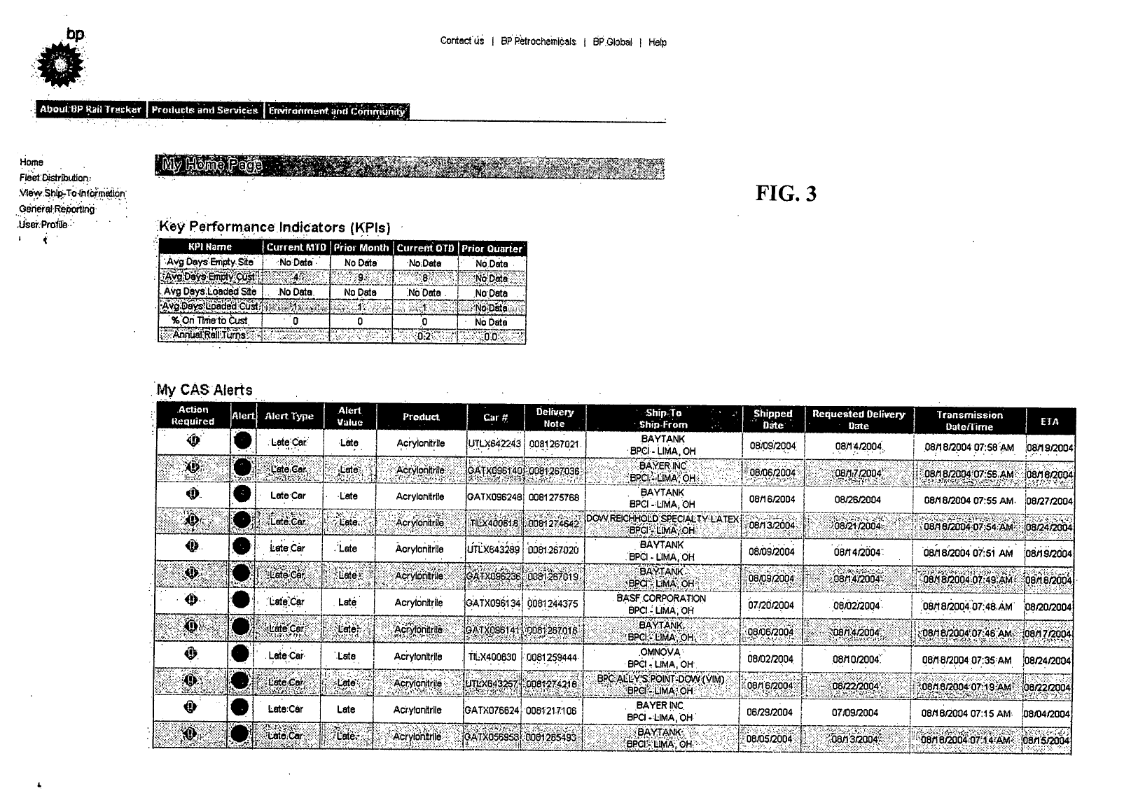

A User wants to view the ETA on a car. The User double-clicks on the Telematics icon on their desktop. The User is prompted to enter their User name and password. The User enters their User name and password and sees the Telematics Home page. (See FIG. 3). The Telematics Home page is personalized for this User based on their role and customized preferences. Alerts appear with red lights and yellow lights next to them to signify items that need attention. A General Reporting link is also available for queries relative to the status of a railcar, including sensor readings and status on orders.

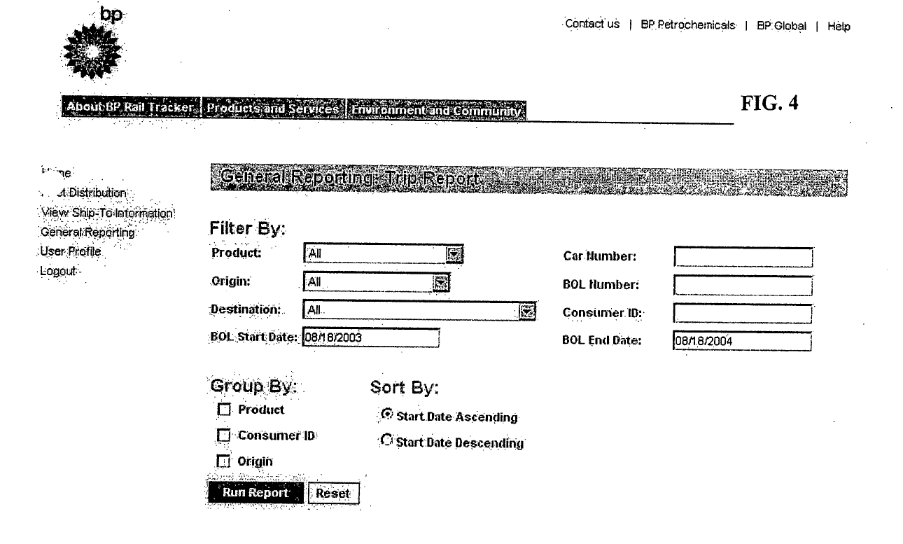

The User clicks on the General Reporting Link and the General Reporting page opens. (See FIG. 4). The page allows the User to generate queries based on various criteria: Product, Customer, Site, Car Number, Fleet, BU, Date Range, Order/BOL Number, Status. In this scenario, the User can view the car ETA based on any of the above criteria. For example, if the User is a Customer Account Specialist (CSR) and wants to view the car ETA for a particular order, they can access the latest status information by typing in the Order of BOL.

The User specifies their selection criteria and clicks on the Search button. The Search results page appears listing the results of their selection criteria. In the case where a User enters an Order Number, the results page would list the associated car number and shipment details. The latest car ETA would be included in this list of detailed information. For all cars in-transit, the car status information will always include the view of ETA to the destination location.

### Example 1A

### Site User

A Site User wants to view the ETA on a car. The User double-clicks on the Telematics icon on their desktop. The Site User is prompted to enter their User name and password.

The User enters their User name and password and sees the Telematics Home page. The Telematics Home page is personalized for this User based on their role and customized preferences. Alerts appear with red lights and yellow lights next to them to signify items that need attention. A General Reporting link is also available for queries relative to the status of a railcar, including sensor readings and status on orders.

The User clicks on the link for Inbound to Site or Outbound to Customer and the Inbound to Site or Outbound to Customer report page opens. These pages allow the User to view a specific car ETA Inbound to Site—User is presented with a list of car types inbound to the site by product. The User selects the applicable group and views the ETAs on those cars.

Outbound to Customer—The User is presented with a list of customers with cars inbound to their sites. The User selects the applicable customer and views the ETAs on those cars. The User selects from the list of car types or customers and clicks the Select button.

The User is presented with a graphical report that segments multiple cars into number of days out from the site. The User can click within the graph to access a list of specific cars and view their associated ETA.

1B View Car ETA (Customer, CSR or Terminal Users)

A Customer, CSR or Terminal Coordinator wants to view the ETA on a car. The User double-clicks on the Telematics icon on their desktop. The User is prompted to enter their User name and password.

The User sees the Telematics Home page, including the User's role-specific module. For the Customer User, the page includes a list of customer-specific product types. For the CSR User, the page includes a list of their customer responsibilities. For the Terminal Coordinator, the page includes a list of their terminal responsibilities. The Telematics Home page is personalized for this User based on their role and customized preferences. Alerts appear with red lights and yellow lights next to them to signify items that need attention. A General Reporting link is also available for queries relative to the status of a railcar, including sensor readings and status on orders.

CSR or Terminal Coordinator selects a value from the list. (Customer Users skip to the next step). A list of product types are displayed. These products are representative of the products currently in railcars inside the terminal or customer location. The User selects a product type from the list and clicks the Submit button. The User is presented with a graphical report that segments multiple cars into number of days out from the site. The User can click within the graph to access a list of specific cars and view their associated ETA.

### Example 2

### View Bad Ordered Cars (General Reporting—All Users)

The User wants to view the status on a car. The User double-clicks on the Telematics icon on their desktop. The User is prompted to enter their User name and password. The User sees the Telematics Home page. (FIG. 3). The Telematics Home page is personalized for this User based on their role and customized preferences. Alerts appear with red lights and yellow lights next to them to signify items that need attention. A General Reporting link is also available for queries relative to the status of a railcar, including sensor readings and status on orders.

The User clicks on the General Reporting link and the General Reporting page opens. (FIG. 4). The page allows the User to generate queries based on various criteria: Product, Customer, Site, Car Number, Fleet, BU, Date Range, Order/BOL Number, Status. In this scenario, the User can view the car status of bad-ordered based on any of the above criteria. For example, if the User is a CSR and wants to view the car status for cars en route to their customer, the User can select the destination equal to their customer and the status equal to bad ordered.

The User specifies their selection criteria and clicks on the Search button. The Search results page appears listing the results of their selection criteria. In the case where a User enters a Customer destination and Status, the results page would list the associated car numbers and shipment details. The latest car status of bad ordered would be included in this list of detailed information. For all cars in-transit, the car status information will always include the view of bad ordered cars. Typically, this information would also be included on the User's Home page as an alert of an issue in their responsibility area.

### Example 3

### View Car Status Information (All Users)

The User wants to view the status on a car. The User double-clicks on the Telematics icon on their desktop and is prompted to enter their User name and password. The Telematics Home page (FIG. 3). is personalized for this User based on their role and customized preferences. Alerts appear with red lights and yellow lights next to them to signify items that need attention. A General Reporting link is also available for queries relative to the status of a railcar, including sensor readings and status on orders.

The User clicks on the General Reporting link and the General Reporting page opens. (FIG. 4). The page allows the User to generate queries based on various criteria: Product, Customer, Site, Car Number, Fleet, BU, Date Range, Order/BOL Number, Status. In this scenario, the User can view the car status information based on any of the above criteria. For example, if the User is a CSR and wants to view the car status information for cars en route to their customer, she can select the destination equal to their customer.

The User specifies their selection criteria and clicks on the Search button. The Search results page appears listing the results of their selection criteria. In the case where a User enters a Customer destination, the results page would list the associated order numbers, car numbers and shipment details. For all cars in the system, the latest car status information will always be available to the User at any point in the rail cycle. Typically, this information would also be included on the User's Home page as an alert of an issue in their responsibility area.

### Example 4

### View Environmental and Safety Information (HSSE User)

The HSSE User wants to view the status on cars in their responsibility area. The User double-clicks on the Telematics icon on their desktop. The User is prompted to enter their User name and password and the User sees the Telematics Home page. The Home page includes an Alerts section, outlining both role-based and customized alerts triggered by the latest cars status information. The Telematics Home page is personalized for this User based on their role and customized preferences. Alerts appear with red lights and yellow lights next to them to signify items that need attention. A General Reporting link is also available for queries relative to the status of a railcar, including sensor readings and status on orders.

The User clicks on the alert and details of the alert situation are displayed, along with pertinent car status information and comments. Details of the alert are presented in the context of a rail turn, of which a particular customer order can be a part. Both historical car status information (relative to current turn) and the latest car status information are included on this page. The rail turn is broken down into four key areas (each of which contains status information) Plant Site, In-transit to Customer, Customer Site, In-transit to Plant Site. The User can select to obtain further information by “drilling down” into the database by navigating through drop-down menus. For example, the HSSE User can conduct a risk assessment by obtaining population information in the area of a collision or leak. Also, the User can obtain maps of the area and stored satellite images.

All United States patents identified above are hereby incorporated by reference.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method for managing mobile shipping units, the method comprising the steps of:
monitoring at least one operational characteristic of the mobile shipping unit, the operational characteristic selected from the group consisting of internal temperature, external temperature, acceleration, weight, hatch status and combinations thereof;
monitoring the location of the mobile shipping unit with a global positioning system;
communicating at scheduled intervals data comprising the location and monitored characteristic from the mobile shipping unit to a receiving device that is remote from the mobile shipping unit;
storing the data received by the receiving device in a status database, wherein the status database is in electronic communication with a data processing unit;
processing the data stored in the status database with the data processing unit to generate at least one report on the mobile shipping unit and to determine if an alert condition exists, wherein an alert condition exists when any data point is outside predetermined limits;
determining a nature and severity of any existing alert condition;
generating an alert notification based on the nature and severity of the alert condition; and,
providing access to the reports and alerts via a network, the network comprising the Internet, an intranet or a combination of both.

2. The method of claim 1, wherein different reports and/or alerts are generated for different Users, wherein the reports are adapted based on the User's role.

3. The method of claim 1a, further comprising the step of allowing individual Users to format the report generated for that User's role.

4. The method of claim 1, wherein a User may select optional alert notification pathways.

5. The method of claim 1, wherein a User may signal the mobile shipping unit to provide updated conditions.

6. The method of claim 1, further comprising the step of differentiating between single occurrence alerts and recurring alerts.

7. The method of claim 1, further comprising the steps of:
determining that a previous alert condition is no longer in alert condition;
determining whether the previous alert condition is permitted to be auto-cleared, and
automatically clearing an alert notification when the alert condition is no longer present and the alert condition is permitted to be auto-cleared.

8. The method of claim 2, wherein the User has a logistical role and the report and alert notifications are adapted to show idle and/or bad-ordered mobile shipping units.

9. The method of claim 2, wherein the User has a safety or maintenance role and the report and alert notifications are adapted to show acceleration incidents representing collisions with the mobile shipping units.

10. The method of claim 1, wherein the mobile shipping units are railcars, ships or barges.

11. The method of claim 1, wherein the mobile shipping units are railcars.

12. A method to minimize environmental contamination during transportation; the method comprising the steps of:
monitoring the current loaded weight and location of a mobile transport unit, wherein the unit contains a potentially environmentally hazardous material;
communicating at scheduled intervals data comprising the location and loaded weight from the mobile shipping unit to a processing system that is remote from the mobile transport unit;
comparing the current loaded weight of the mobile shipping unit with a target loaded weight, the target loaded weight being an average of previously communicated loaded weights, the immediately previously communicated loaded weight, or an original loaded weight;
determining if the mobile transport unit is within a predetermined geofence, the geofence defining a boundary around a station for loading or unloading the material from the mobile transport unit;
communicating an alert message if both (1) the comparison of the current loaded weight with the target loaded weight determines that the loaded weight has changed by more than a predetermined amount and (2) the mobile unit is not within a geofence, are true.

13. The method of claim 12, wherein the alert message is communicated to a User having environmental safety responsibility for the material.

14. The method of claim 13, wherein the User can communicate with the mobile transport unit to request an update on loaded weight and location.

15. The method of claim 13 further comprising the step of providing access to the User to risk assessment data, the risk assessment data comprising one or more of maps showing the current location of the transport unit, satellite images of the current location of the transport unit, population density proximate to the current location of the transport unit, location of any bodies of water proximate to the current location of the transport unit, and identity and location of any high-risk facilities proximate to the current location of the transport unit.

16. The method of claim 12, further comprising the steps of:
monitoring the acceleration of the mobile transport unit; and
communicating an alert message if the change in acceleration exceeds a predetermined limit.

17. The method of claim 12, further comprising the steps of:
monitoring the internal temperature of the mobile transport unit; and
communicating an alert message if the internal temperature exceeds a predetermined limit.

18. The method of claim 12, wherein the mobile shipping units are railcars, ships or barges.

19. The method of claim 12, wherein the mobile shipping units are railcars.

20. A system for managing mobile shipping units, the system comprising:
means for monitoring at least one operational characteristic of the mobile shipping unit, the operational characteristic selected from the group consisting of internal temperature, external temperature, acceleration, weight, hatch status and combinations thereof;
means for monitoring the location of the mobile shipping unit with a global positioning system;
means for communicating at scheduled intervals data comprising the location and monitored characteristic from the mobile shipping unit to a receiving device that is remote from the mobile shipping unit;
a status database for storing the data received by the receiving device in a status database;
a data processing unit in electronic communication with the status database, the data processing unit adapted to process the data stored in the status database to: (1) generate at least one report on the mobile shipping unit and to determine if an alert condition exists, wherein an alert condition exists when any data point is outside predetermined limits; (2) determine a nature and severity of any existing alert condition; and (3) generate an alert notification based on the nature and severity of the alert condition; and,
means for providing access to the reports and alerts via a network, the network comprising the Internet, an intranet or a combination of both.

21. The system of claim 20, wherein the mobile shipping unit is a railcar, ship or barge.

22. The system of claim 20, wherein the mobile shipping unit is a railcar.

23. The system of claim 20, wherein the means for communicating is a satellite linkage.

24. A method for monitoring the status of a mobile shipping unit, the method comprising the steps of:
communicating data comprising the location and monitored characteristics from the mobile shipping unit to a receiving device that is remote from the mobile shipping unit, wherein the monitored characteristics comprise at least one of internal temperature, external temperature, acceleration, weight, hatch status or combinations thereof;
storing the data received by the receiving device in a status database, wherein the status database is in electronic communication with a data processing unit;
processing the data stored in the status database with the data processing unit to generate at least one report on the mobile shipping unit, wherein the report comprises at least one of an estimated time of arrival for the mobile shipping unit, idle time, mis-routing of the mobile shipping unit, cargo status, key performance indices, or fleet performance statistics; and
providing access to the reports and alerts via a network, the network comprising the Internet, an intranet or a combination of both.

25. The method of claim 24, further comprising:
providing notification to the status database that the mobile shipping unit is classified as bad ordered.

26. The method of claim 24, further comprising:
processing the data stored in the status database with the data processing unit to determine if an alert condition exists, wherein an alert condition exists when any data point is outside predetermined limits;
determining a nature and severity of any existing alert condition; and,
generating an alert notification based on the nature and severity of the alert condition.

27. The method of claim 24, further comprising inputting data from other databases to the status database, wherein the other databases comprise at least one of a CLM sighting database, an ERP software application, or an equipment fleet list database.

28. The method of claim 24 wherein different Users may have different roles and the reports are adapted based on the role of the User.

29. The method of claim 28, wherein the User's role comprises customer account service and the reports are limited to mobile shipping units in transit to, located at, or in transit from, a site of a customer that User is responsible for.

30. The method of claim 28, wherein the User's role is a customer and the reports are limited to mobile shipping units in transit to, located at, or in transit from, a site of the customer.

31. The method of claim 28, wherein the User's role comprises management of a loading and/or manufacturing site and the reports are limited to mobile shipping units in transit to, located at, or in transit from, the loading and/or manufacturing site.

32. The method of claim 24, wherein the report includes notification of the presence of a heel in a mobile shipping unit in transit to the loading and/or manufacturing site.

33. The method of claim 28, wherein the User's role is yard management and the reports are comprised notification of the location and spot data of mobile shipping units within the yard.

34. The method of claim 24, wherein the mobile shipping units are railcars, ships or barges.

35. The method of claim 24, wherein the mobile shipping units are railcars.

36. A method for automatic invoicing, the method comprising:
communicating data comprising the location, weight, and, optionally, the hatch status, of a mobile shipping unit to a receiving device that is remote from the mobile shipping unit;
storing the data received by the receiving device in a status database, wherein the status database is in electronic communication with a data processing unit;
storing bill of lading information for the mobile shipping unit in the status database;
processing the data stored in the status database with the data processing unit to determine if the mobile shipping unit has been tapped and/or unloaded by a customer; and
communicating the tapped/unloaded status of the mobile shipping unit to an ERP software application.

37. The method of claim 36, further comprising generating an invoice to the customer if the mobile shipping unit has a cargo on consignment and the mobile shipping unit has a tapped status.

38. The method of claim 36, further comprising:
determining the date that a mobile shipping unit is unloaded by a customer;
receiving notification of the date that the customer released the unloaded mobile shipping unit for return transit;
comparing the date the customer released the mobile shipping unit to the date that the customer unloaded the mobile shipping unit to determine if demurrage charges are due; and,
automatically generating an invoice to the customer for any due demurrage charges.

39. The method of claim 36, wherein the mobile shipping units are railcars, ships or barges.

40. The method of claim 36, wherein the mobile shipping units are railcars.

41. An article of manufacture comprising a computer readable medium having a database comprising monitored characteristics of a mobile shipping unit that is remote from the computer readable medium, wherein the monitored characteristics comprise at least one of internal temperature, external temperature, acceleration, weight, hatch status or combinations thereof.

42. An article of manufacture comprising a computer readable medium comprising code to process data stored in a status database, wherein the status database maintains status information of monitored characteristics of a mobile comprise at least one of internal temperature, external temperature, acceleration, weight, hatch status or combinations thereof, to: (1) generate at least one report on the mobile shipping unit and to determine if an alert condition exists, wherein an alert condition exists when any data point is outside predetermined limits; (2) determine a nature and severity of any existing alert condition; and (3) generate an alert notification based on the nature and severity of the alert condition.

43. A system comprising:
(A) a computer readable medium having a database comprising monitored characteristics of a mobile shipping unit that is remote from the computer readable medium, wherein the monitored characteristics comprise at least one of internal temperature, external temperature, acceleration, weight, hatch status or combinations thereof; and,
(B) a computer readable medium comprising code to process data stored in the database to: (1) generate at least one report on the mobile shipping unit and to determine if an alert condition exists, wherein an alert condition exists when any data point is outside predetermined limits; (2) determine a nature and severity of any existing alert condition; and (3) generate an alert notification based on the nature and severity of the alert condition.
